(19) United States
(12) Patent Application Publication
(10) Pub. No.: US 2025/0220504 A1
(43) Pub. Date: Jul. 3, 2025

(54) LINK ADAPTATION FEEDBACK FOR RELAY COMMUNICATIONS

(71) Applicant: Ofinno, LLC, Reston, VA (US)

(72) Inventors: Tuncer Baykas, Reston, VA (US); Jeongki Kim, Fairfax, VA (US); Esmael Hejazi Dinan, McLean, VA (US); Leonardo Alisasis Lanante, Reston, VA (US); Serhat Erkucuk, Reston, VA (US); Jiayi Zhang, Rockville, MD (US)

(21) Appl. No.: 19/002,870

(22) Filed: Dec. 27, 2024

Related U.S. Application Data
(60) Provisional application No. 63/615,812, filed on Dec. 29, 2023.

(51) Int. Cl. H04W 28/06; H04W 88/04

(52) U.S. Cl. CPC H04W 28/06; H04W 88/04

(57) ABSTRACT

A first station (STA) receives from a second STA a first frame comprising first link adaptation feedback for a link between the first STA and the second STA. The first STA transmits to a third STA a second frame comprising second link adaptation feedback for the link between the first STA and the second STA. The third STA may use the second link adaptation feedback to adapt a modulation and coding scheme (MCS), a number of spatial streams, a bandwidth, a transmission power, or a resource unit (RU) allocation used for data frames transmitted via the link and may transmit to the first STA a third frame comprising link adaptation information for the link. The first STA may set, based on the link adaptation information, the MCS, the number of spatial streams, the bandwidth, the transmission power, or the RU allocation used for data frames transmitted via the link.

### CROSS-REFERENCE TO RELATED APPLICATIONS

This application claims the benefit of U.S. Provisional Application No. 63/615,812, filed Dec. 29, 2023, which is hereby incorporated by reference in its entirety.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of a Medium Access Control (MAC) frame format.

FIG. 4 illustrates an example of a Quality of Service (QOS) null frame indicating buffer status information.

FIG. 5 illustrates an example format of a physical layer (PHY) protocol data unit (PPDU).

FIG. 6 illustrates an example of a sub-1 GHz (S1G) relay architecture.

FIG. 7 illustrates an example of source-relay-destination link.

FIG. 8 is an example that illustrates relaying with no transmission opportunity (TXOP) protection.

FIG. 9 illustrates an example of Request-to-Send (RTS)/Clear-to-Send (CTS) procedure.

FIG. 10 is an example that illustrates relaying with TXOP protection.

FIG. 11 illustrates an example of an obstruction changing the link quality between a relay and a-destination.

FIG. 12 illustrates an example of a procedure which may be used by a first STA to inform a second STA of a change in the quality of a link between the first STA and the second STA.

FIG. 13 illustrates an example of a Directional Multi-Gigabit (DMG) Link Margin element.

FIG. 14 illustrates an example of a relay link adaptation procedure according to an embodiment.

FIG. 15 illustrates a link adaptation procedure for relay communications according to an embodiment.

FIG. 16 illustrates a link adaptation procedure for relay communications according to another embodiment.

FIG. 17 illustrates a link adaptation procedure for relay communications according to another embodiment.

FIG. 18 illustrates an example of a High Efficiency (HE) link adaptation (HLA) control subfield.

FIG. 19 illustrates an example of an Extremely High Throughput (EHT) link adaptation (ELA) control subfield.

FIG. 20 illustrates an example process according to an embodiment.

FIG. 21 illustrates another example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of′, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

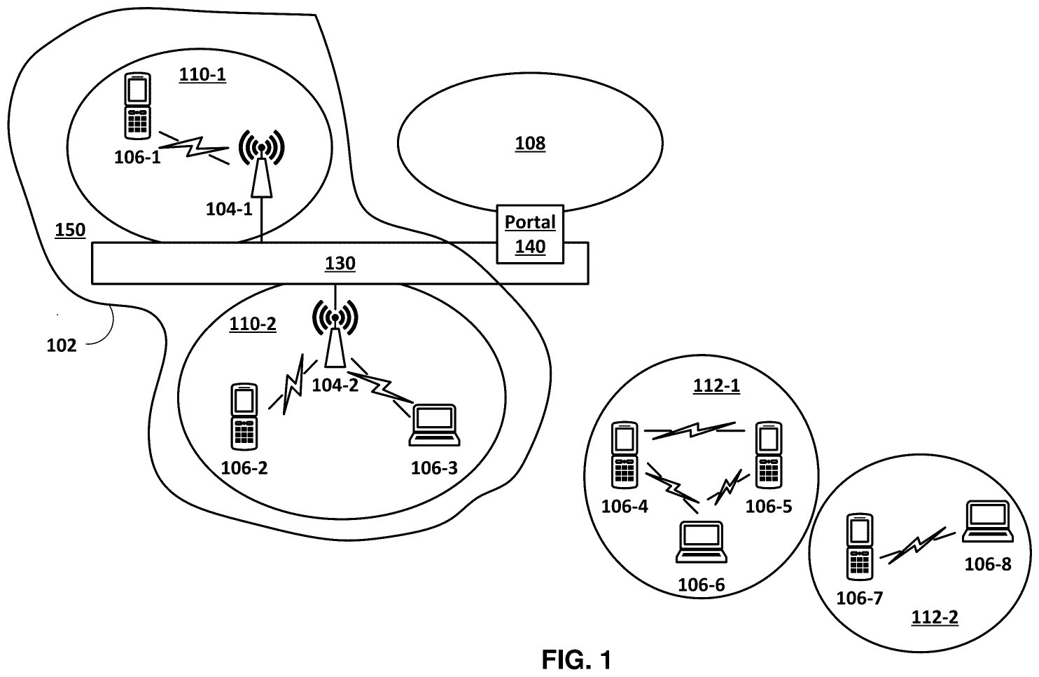

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other . . .

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PLCP service data unit (PSDU). For example, the PSDU may include a PHY Convergence Protocol (PLCP) preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHZ, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 520 MHz by bonding together multiple 20 MHz channels.

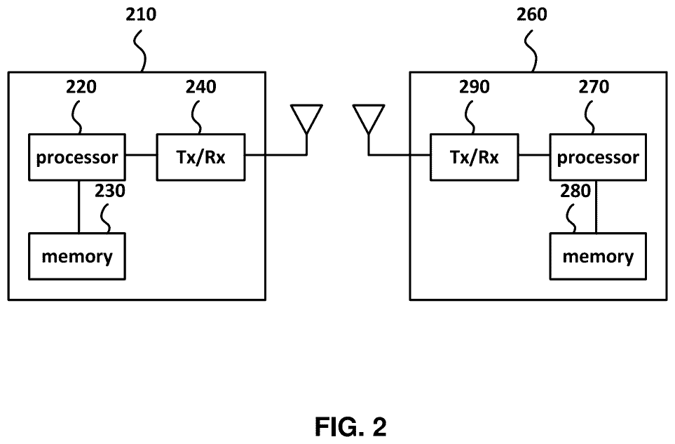

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

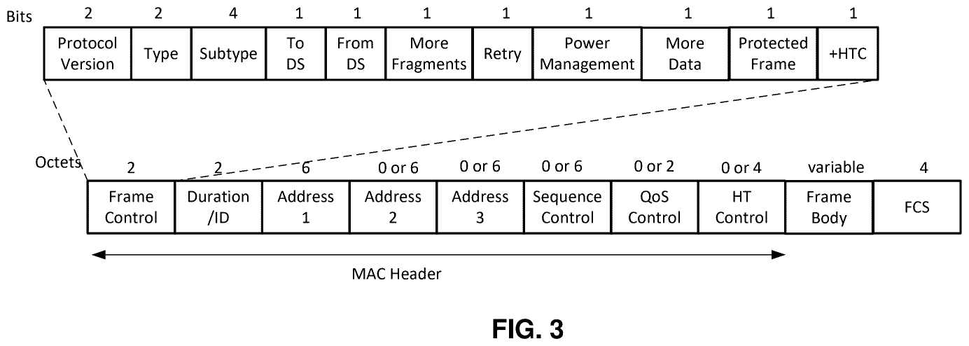

FIG. 3 illustrates an example format of a MAC frame. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, a MAC frame includes a MAC header, a variable length frame body, and a frame check sequence (FCS).

The MAC header includes a frame control field, an optional duration/ID field, address fields, an optional sequence control field, an optional QoS control field, and an optional HT control field.

The frame control field includes the following subfields: protocol version, type, subtype, “To DS”, “From DS”, “More Fragments”, retry, power management, “More Data, protected frame, and +HTC.

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS data frame, which is a data frame that contains a QoS control field in its MAC header. The second MSB of the subtype field, bit 6 (B6) of the frame control field, when set to 1 in data subtypes, indicates a data frame that contain no frame body field.

The “To DS” subfield indicates whether a data frame is destined to the distribution system (DS). The “From DS” subfield indicates whether a data frame originates from the DS.

The “More Fragments” subfield is set to 1 in all data or management frames that have another fragment to follow the MAC service data unit (MSDU) or MAC management protocol data unit (MMPDU) carried by the MAC frame. The “More Fragments” subfield is set to 0 in all other frames in which the “More Fragments” subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The “More Data” subfield indicates to a STA in power save (PS) mode that bufferable units (BUs) are buffered for that STA at the AP. The “More Data” subfield is valid in individually addressed data or management frames transmitted by an AP to a STA in PS mode. The “More Data” subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that the MAC frame contains an HT control field.

The duration/ID field of the MAC header indicates various contents depending on the frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), with the 2 most significant bits (MSB) set to 1. In other frames sent by STAs, the duration/ID field contains a duration value (in microseconds) which is used by a recipient to update a network allocation vector (NAV). The NAV is a counter that indicates to a STA an amount of time during which the STA must defer from accessing the shared medium.

Up to four address fields may be present in the MAC frame format. The address fields are used to indicate the basic service set identifier (BSSID), source address (SA), destination address (DA), transmitting address (TA), and receiving address (RA). Certain frames may not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which the MAC frame belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field.

The frame body field is a variable length field that contains information specific to individual frame types and subtypes. The frame body may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

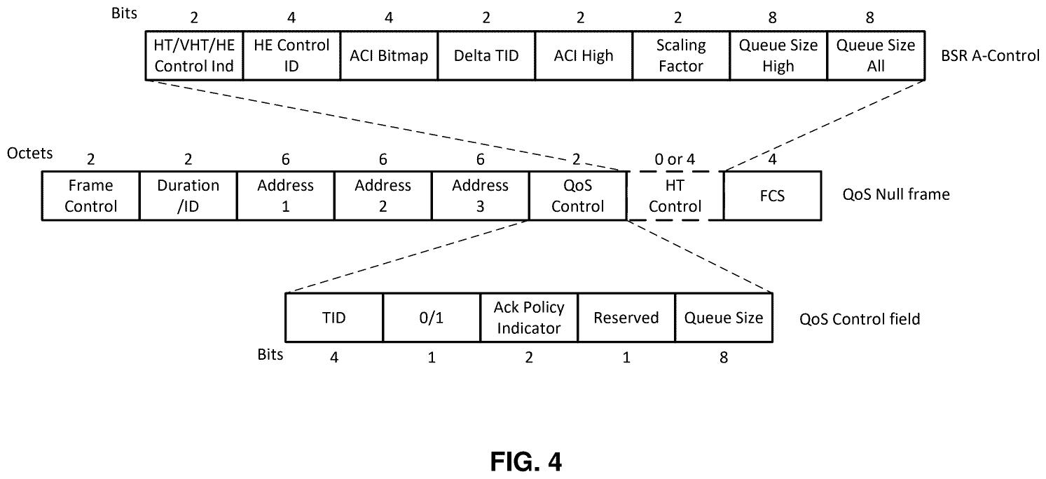

FIG. 4 illustrates an example of a QoS null frame indicating buffer status information. A QoS null frame refers to a QoS data frame with an empty frame body. A QoS null frame includes a QoS control field and an optional HT control field which may contain a buffer status report (BSR) control subfield. A QoS null frame indicating buffer status information may be transmitted by a STA to an AP.

The QoS control field may include a traffic identifier (TID) subfield, an ack policy indicator subfield, and a queue size subfield (or a transmission opportunity (TXOP) duration requested subfield).

The TID subfield identifies the TC or TS of traffic for which a TXOP is being requested, through the setting of the TXOP duration requested or queue size subfield. The encoding of the TID subfield depends on the access policy (e.g., Allowed value 0 to 7 for enhanced distributed channel access (EDCA) access policy to identify user priority for either TC or TS).

The ack policy indicator subfield, together with other information, identifies the acknowledgment policy followed upon delivery of the MPDU (e.g., normal ack, implicit block ack request, no ack, block ack, etc.)

The queue size subfield is an 8-bit field that indicates the amount of buffered traffic for a given TC or TS at the STA for transmission to the AP identified by the receiver address of the frame containing the subfield. The queue size subfield is present in QoS null frames sent by a STA when bit 4 of the QoS control field is set to 1. The AP may use information contained in the queue size subfield to determine t TXOP duration assigned to the STA or to determine the uplink (UL) resources assigned to the STA.

In a frame sent by or to a non-High Efficiency (non-HE) STA, the following rules may apply to the queue size value:
The queue size value is the approximate total size, rounded up to the nearest multiple of 256 octets and expressed in units of 256 octets, of all MSDUs and A-MSDUs buffered at the STA (excluding the MSDU or A-MSDU contained in the present QoS Data frame) in the delivery queue used for MSDUs and A-MSDUs with TID values equal to the value indicated in the TID subfield of the QoS Control field.
A queue size value of 0 is used solely to indicate the absence of any buffered traffic in the queue used for the specified TID.
A queue size value of 254 is used for all sizes greater than 64 768 octets.
A queue size value of 255 is used to indicate an unspecified or unknown size.

In a frame sent by an HE STA to an HE AP, the following rules may apply to the queue size value.

The queue size value, [symbol] S, is the approximate total size in octets, of all MSDUs and A-MSDUs buffered at the STA (including the MSDUs or A-MSDUs contained in the same PSDU as the frame containing the queue size subfield) in the delivery queue used for MSDUs and A-MSDUs with TID values equal to the value indicated in the TID subfield of the QoS control field.

The queue size subfield includes a scaling factor subfield in bits B14-B15 of the QoS control field and an unscaled value, UV, in bits B8-B13 of the QoS control field. The scaling factor subfield provides the scaling factor, SF.

A STA obtains the queue size, [symbol] S, from a received QoS control field, which contains a scaling factor, SF, and an unscaled value, UV, as follows:
[symbol] S=
16×UV, if SF is equal to 0;
1024+256× UV, if SF is equal to 1;
17 408+2048× UV, if SF is equal to 2;
148 480+32 768× UV, if SF is equal to 3 and UV is less than 62;
>2 147 328, if SF equal to is 3 and UV is equal to 62;
Unspecified or Unknown, if SF is equal to 3 and UV is equal to 63.

The TXOP duration requested subfield, which may be included instead of the queue size subfield, indicates the duration, in units of 32 microseconds (us), that the sending STA determines it needs for its next TXOP for the specified TID. The TXOP duration requested subfield is set to 0 to indicate that no TXOP is requested for the specified TID in the current service period (SP). The TXOP duration requested subfield is set to a nonzero value to indicate a requested TXOP duration in the range of 32 us to 8160 us in increments of 32 us.

The HT control field may include a BSR control subfield which may contain buffer status information used for UL MU operation. The BSR control subfield may be formed from an access category index (ACI) bitmap subfield, a delta TID subfield, an ACI high subfield, a scaling factor subfield, a queue size high subfield, and a queue size all subfield of the HT control field.

The ACI bitmap subfield indicates the access categories (ACs) for which buffer status is reported (e.g., B0: best effort (AC_BE), B1: background (AC_BK), B2: video (AC_VI), B3: voice (AC_VO), etc.). Each bit of the ACI bitmap subfield is set to 1 to indicate that the buffer status of the corresponding AC is included in the queue size all subfield, and set to 0 otherwise, except that if the ACI bitmap subfield is 0 and the delta TID subfield is 3, then the buffer status of all 8 TIDs is included.

The delta TID subfield, together with the values of the ACI bitmap subfield, indicate the number of TIDs for which the STA is reporting the buffer status.

The ACI high subfield indicates the ACI of the AC for which the BSR is indicated in the queue size high subfield. The ACI to AC mapping is defined as ACI value 0 mapping to AC_BE, ACI value 1 mapping to AC_BK, ACI value 2 mapping to AC_VI, and ACI value 3 mapping to AC_VO.

The scaling factor subfield indicates the unit SF, in octets, of the queue size high and queue size all subfields.

The queue size high subfield indicates the amount of buffered traffic, in units of SF octets, for the AC identified by the ACI high subfield, that is intended for the STA identified by the receiver address of the frame containing the BSR control subfield.

The queue size all subfield indicates the amount of buffered traffic, in units of SF octets, for all ACs identified by the ACI Bitmap subfield, that is intended for the STA identified by the receiver address of the frame containing the BSR control subfield.

The queue size values in the queue size high and queue size all subfields are the total sizes, rounded up to the nearest multiple of SF octets, of all MSDUs and A-MSDUs buffered at the STA (including the MSDUs or A-MSDUs contained in the same PSDU as the frame containing the BSR control subfield) in delivery queues used for MSDUs and A-MSDUs associated with AC(s) that are specified in the ACI high and ACI bitmap subfields, respectively.

A queue size value of 254 in the queue size high and queue size all subfields indicates that the amount of buffered traffic is greater than 254× SF octets. A queue size value of 255 in the queue size high and queue size all subfields indicates that the amount of buffered traffic is an unspecified or unknown size. The queue size value of QoS data frames containing fragments may remain constant even if the amount of queued traffic changes as successive fragments are transmitted.

MAC service provides peer entities with the ability to exchange MSDUs. To support this service, a local MAC uses the underlying PHY-level service to transport the MSDUs to a peer MAC entity. Such asynchronous MSDU transport is performed on a connectionless basis.

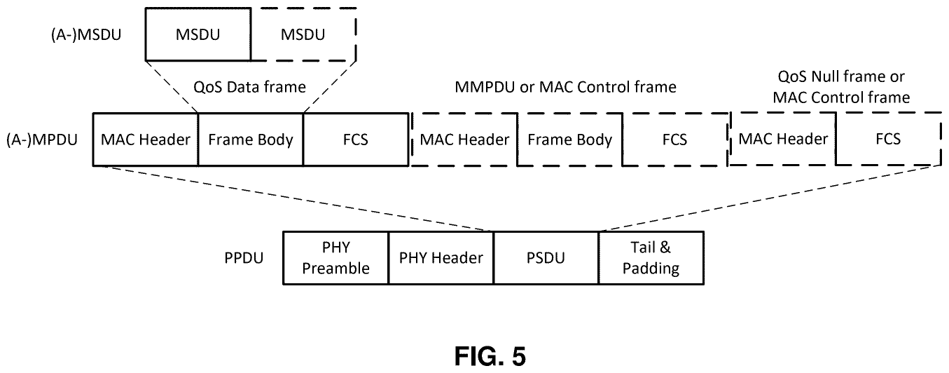

FIG. 5 illustrates an example format of a PPDU. As shown, the PPDU may include a PHY preamble, a PHY header, a PSDU, and tail and padding bits.

The PSDU may include one or more MPDUs, such as a QoS data frame, an MMPDU, a MAC control frame, or a QoS null frame. In the case of an MPDU carrying a QoS data frame, the frame body of the MPDU may include a MSDU or an A-MSDU.

By default, MSDU transport is on a best-effort basis. That is, there is no guarantee that a transmitted MSDU will be delivered successfully. However, the QoS facility uses a traffic identifier (TID) to specify differentiated services on a per-MSDU basis.

A STA may differentiate MSDU delivery according to designated traffic category (TC) or traffic stream (TS) of individual MSDUs. The MAC sublayer entities determine a user priority (UP) for an MSDU based on a TID value provided with the MSDU. The QoS facility supports eight UP values. The UP values range from 0 to 7 and form an ordered sequence of priorities, with 1 being the lowest value, 7 the highest value, and 0 falling between 2 and 3.

An MSDU with a particular UP is said to belong to a traffic category with that UP. The UP may be provided with each MSDU at the medium access control service access point (MAC SAP) directly in a UP parameter. An A-MPDU may include MPDUs with different TID values.

A STA may deliver buffer status reports (BSRs) to assist an AP in allocating UL MU resources. The STA may either implicitly deliver BSRs in the QoS control field or BSR control subfield of any frame transmitted to the AP (unsolicited BSR) or explicitly deliver BSRs in a frame sent to the AP in response to a BSRP Trigger frame (solicited BSR).

The buffer status reported in the QoS control field includes a queue size value for a given TID. The buffer status reported in the BSR control field includes an ACI bitmap, delta TID, a high priority AC, and two queue sizes.

A STA may report buffer status to the AP, in the QoS control field, of transmitted QoS null frames and QoS data frames and, in the BSR control subfield (if present), of transmitted QoS null frames, QoS data frames, and management frames as defined below.

The STA may report the queue size for a given TID in the queue size subfield of the QoS control field of transmitted QoS data frames or QoS null frames; the STA may set the queue size subfield to 255 to indicate an unknown/unspecified queue size for that TID. The STA may aggregate multiple QoS data frames or QoS null frames in an A-MPDU to report the queue size for different TIDs.

The STA may report buffer status in the BSR control subfield of transmitted frames if the AP has indicated its support for receiving the BSR control subfield.

A High-Efficiency (HE) STA may report the queue size for a preferred AC, indicated by the ACI high subfield, in the queue size high subfield of the BSR control subfield. The STA may set the queue size high subfield to 255 to indicate an unknown/unspecified queue size for that AC.

A HE STA may report the queue size for ACs indicated by the ACI bitmap subfield in the queue size all subfield of the BSR control subfield. The STA may set the queue size all subfield to 255 to indicate an unknown/unspecified BSR for those ACs.

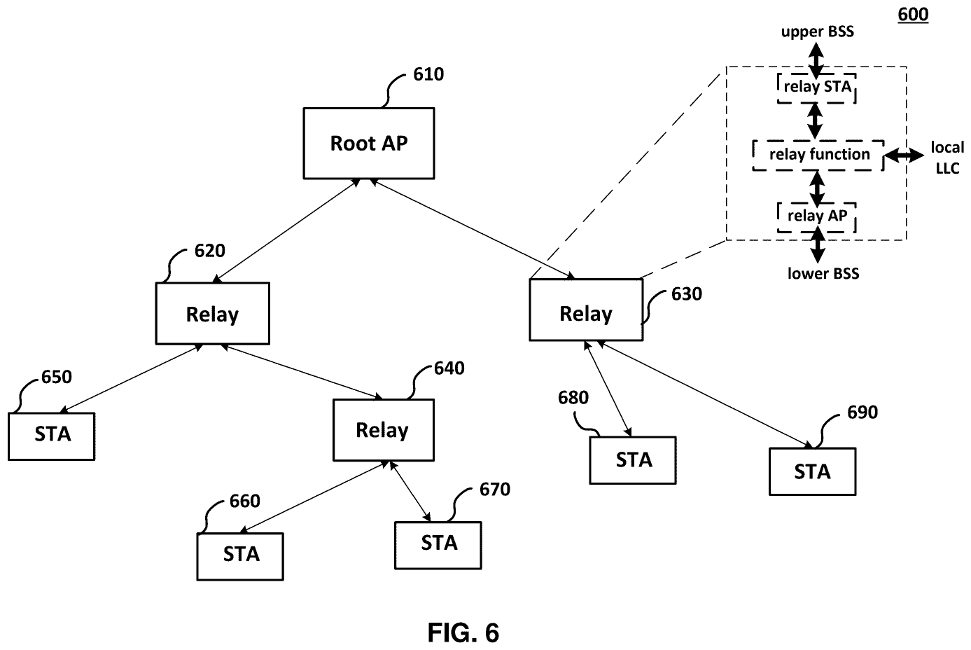

FIG. 6 illustrates an example sub-1 GHz (S1G) relay architecture 600. Example SIG relay architecture 600 may be an example according to the SIG relay operation as defined in section 10.54.1 of the IEEE 802.11 standard draft “IEEE P802.11-REVme™/D2.1, January 2023.” As shown in FIG. 6, example SIG relay architecture 600 may include a root AP 610, relays 620, 630 and 640, and STAs 650, 660, 670, 680 and 690.

S1G relay is a mechanism for expanding the coverage area of an AP, referred to as the root AP. In example SIG relay architecture 600, the SIG relay mechanism is being used to expand the coverage area of root AP 610.

As shown in FIG. 6, relays 620, 630 and 640 may each comprise a relay AP, a relay STA, and a relay function. The relay STA communicates with an upper BSS, whereas the relay AP communicates with a lower BSS. The relay function performs local reception or selective forwarding of MSDUs between the relay STA and the relay AP, based on destination address. In an example, relays 620 and 630 are associated with root AP 610. Relay 640 may be associated with relay 620. In an example, STA 650 is associated with relay 620. STAs 660 and 670 may be associated with relay 640. STAs 680 and 690 may be associated with relay 630.

In an example, frames from STA 650 are forwarded via the relay function of relay 620 (from the relay AP to the relay STA of relay 620) to root AP 610. In the reverse direction, frames from root AP 610 are forwarded to STA 650 via the relay function of relay 620 (from the relay STA to the relay AP of relay 620). Similarly, STAs 680 and 690 may communicate with root AP 610 via relay 630 in both directions (e.g., uplink and downlink). On the other hand, STAs 660 and 670 may use relays 640 and 620 consecutively to communicate with root AP 610.

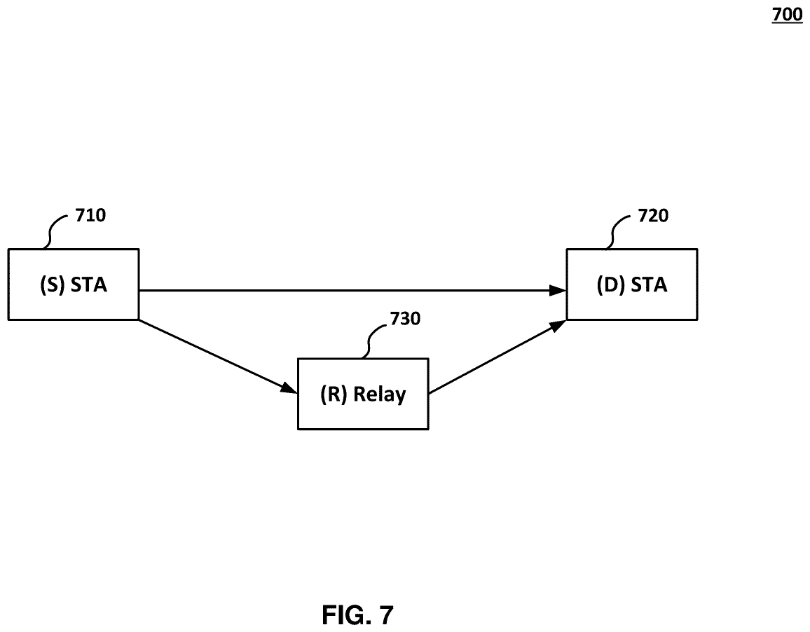

FIG. 7 illustrates an example 700 of a source-relay-destination link. As shown in FIG. 7, source-relay-destination link 700 may comprise a STA 710 as a source STA, a STA 720 as a destination STA, and a relay 730.

STA 710 may be a non-AP STA or an AP STA. Similarly, STA 720 may be a non-AP STA or an AP STA. Relay 730 may comprise a relay AP, a relay STA, and a relay function as described in FIG. 7 above. In an embodiment, STA 710 may be an AP STA and STA 720 may be a non-AP STA, or vice versa. In another embodiment, STAs 710 and 720 both may be AP STAs or non-AP STAs. STAs 710 and 720 may communicate directly.

Due to unreliable communication or to extend the range of existing communication, STA 710 may use relay 730 to communicate with STA 720. As such, STA 710 may transmit data frames destined to STA 720 via relay 730. STA 710 and/or the relay 730 may choose to protect the transmitted data frames with TXOP protection while relaying the data frames via relay 730. In another embodiment, STA 710 and/or relay 730 may choose not to protect the data frames with TXOP protection while relaying the data frames via relay 730.

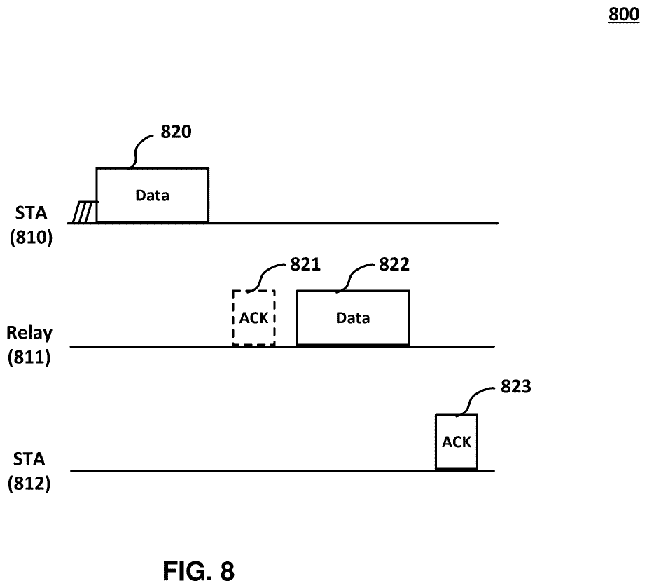

FIG. 8 is an example 800 that illustrates relaying with no transmission opportunity (TXOP) protection. Example 800 may be an example according to the TXOP sharing procedures for S1G relay operation as defined in section 10.54.5 of the IEEE 802.11 standard draft “IEEE P802.11-REVme™/D2.1, January 2023.” As shown in FIG. 8, example 800 may include STAs 810 and 812 and relay 811.

In example 800, STA 810 may be a STA that supports TXOP sharing procedures. As shown in FIG. 8, STA 810 may transmit a data frame 820 destined to STA 812 via relay 811. Data frame 820 may be a protocol version 1 (PV1) QOS data frame. In an implementation, STA 810 may set a Relayed Frame field in a Frame Control field of data frame 820 to 1. The Relayed Frame field set to 1 indicates a relay-shared TXOP. On receiving data frame 820 with the Relay Frame field set to 1, relay 811 may transmit an ACK frame 821 if an explicit ACK procedure is used. Alternatively, relay 811 may not transmit an ACK frame if an implicit ACK procedure is used.

In example 800, relay 811 may transmit data frame 822 to STA 812 without protecting data frame 822. STA 812 may transmit an ACK frame 823 after receiving data frame 822 from relay 811. Relaying without TXOP protection may allow a lower latency transmission of data frame 820 from STA 810 to STA 812. However, communication may be less reliable in case that other STAs of the same BSS may be present within the communication ranges of STAs 810, 812 and relay 811. To improve communication reliability, an RTS/CTS procedure may be used to protect relayed data frames as further described below.

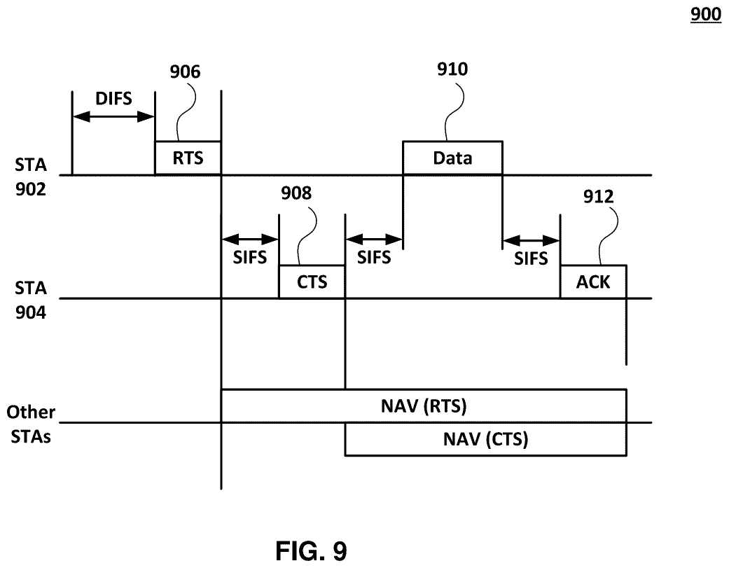

FIG. 9 illustrates an example a Request-to-Send (RTS)/Clear-to-Send (CTS) procedure 900. Example RTS/CTS procedure 900 may be an example according to the RTS/CTS procedure as defined in section 10.3.2.9 of the IEEE 802.11 standard draft “IEEE P802.11-REVme™/D2.1, January 2023.” As shown in FIG. 9, example RTS/CTS procedure 900 may include STAs 902 and 904. Other STAs of the same BSS may also be within communication range of STAs 902 and 904.

In an example, STA 902 may transmit an RTS frame 906 to STA 904. STA 902 may transmit RTS frame 906 to protect from hidden STA(s) the transmission of a data frame 910 that STA 902 intends to transmit. RTS frame 906 may include a Duration/ID field. The Duration/ID field may be set to the time, in microseconds, required to transmit data frame 910, plus one CTS frame, plus one ACK frame (if required), plus three SIFS (Short Interframe Spacing) periods.

In an example, STA 904 may respond to RTS frame 906 by transmitting a CTS frame 908 to STA 902. CTS frame 908 may be transmitted one SIFS period after RTS frame 906. STA 904 may respond to RTS frame 906 when RTS frame 906 is addressed to STA 904 and after considering the NAV, unless the NAV was set by a frame originating from STA 902. STA 904 may respond to the RTS frame 906 when RTS frame 906 is addressed to STA 904 and if the NAV indicates idle. For a non-SIG STA, the NAV indicates idle when the NAV count is 0 or when the NAV count is non-zero but a nonbandwidth signaling TA obtained from a TA field of RTS frame 906 matches a saved TXOP holder address. For an SIG STA, the NAV indicates idle when both the NAV and RID (response indication deferral) counters are 0 or when either the NAV or RID counter is non-zero but the TA field of RTS frame 906 matches the saved TXOP holder address.

STA 904 may set an RA field of CTS frame 908 to a nonbandwidth signaling TA obtained from the TA field of RTS frame 906. STA 904 may set a Duration field of CTS frame 908 based on the Duration/ID field of RTS frame 906, namely as equal to the value of the Duration/ID field of RTS frame 906, adjusted by subtracting the time required to transmit CTS frame 908 and one SIFS period.

Upon receiving CTS frame 908, STA 902 may wait one SIFS period before transmitting data frame 910. STA 904 may transmit an ACK frame 912 in response to data frame 910. STA 904 may transmit ACK frame 912 one SIFS after receiving data frame 910.

As shown in FIG. 9, other STAs within communication range of STAs 902 and 904, and belonging to the same BSS, may set their NAVs according to RTS frame 906 and/or CTS frame 908. For example, a STA receiving RTS frame 906 may set its NAV based on the Duration/ID field of RTS frame 906. Another STA receiving CTS frame 908 may set its NAV based on the Duration field of CTS frame 908. As such, the other STAs may not access the channel using EDCA until the end of transmission of ACK frame 912.

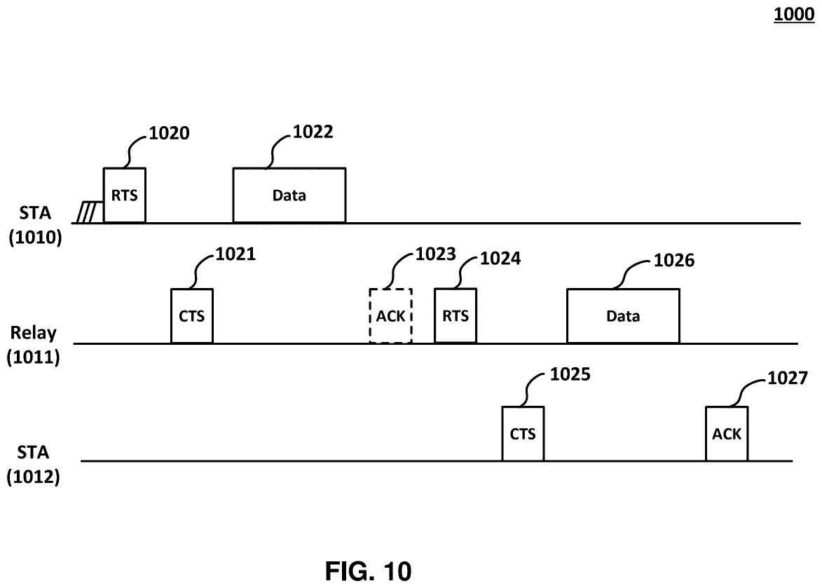

FIG. 10 is an example 1000 that illustrates relaying with TXOP protection. Example 1000 may be an example according to the TXOP sharing procedures for SIG relay operation as defined in section 10.54.5 of the IEEE 802.11 standard draft “IEEE P802.11-REVme™/D2.1, January 2023.” As shown in FIG. 10, example 1000 may include STAs 1010 and 1012 and relay 1011.

In an example, STA 1010 may be a STA that supports TXOP sharing procedures. Before transmitting a data frame 1022 to relay 1011, STA 1010 may transmit an RTS frame 1020 to relay 1011. Relay 1011 may respond to RTS frame 1020 by transmitting a CTS frame 1021 to STA 1010, if its NAV indicates idle. Upon receiving CTS frame 1021, STA 1010 may transmit data frame 1022 to relay 1011. Relay 1011 may transmit an ACK frame 1023 if an explicit ACK procedure is used. Alternatively, relay 1011 may not transmit an ACK frame if an implicit ACK procedure is used.

Similarly, before relaying receive data frame 1022 onto STA 1012, relay 1011 may transmit an RTS frame 1024 to STA 1012. STA 1012 may respond to RTS frame 1024 by transmitting a CTS frame 1025 to relay 1011, if its NAV indicates idle. Upon receiving CTS frame 1025, relay 1011 may transmit a data frame 1026 (relay of data frame 1022) to STA 1012. STA 1012 may transmit an ACK frame 1027 to relay 1011 after receiving data frame 1026.

Relaying with TXOP protection provides a more reliable approach to transmit data frames from a source STA to a destination STA. This may be achieved by using the RTS/CTS procedure sequentially in source-to-relay and relay-to-destination links. However, where the relay-to-destination link is not available due to a busy medium, there may be a delay until the relay receives a CTS frame from the destination STA and can transmit the data frame to the destination STA. An end-to-end approach that provides TXOP protection for both links may thus be more suitable to prevent any such delays.

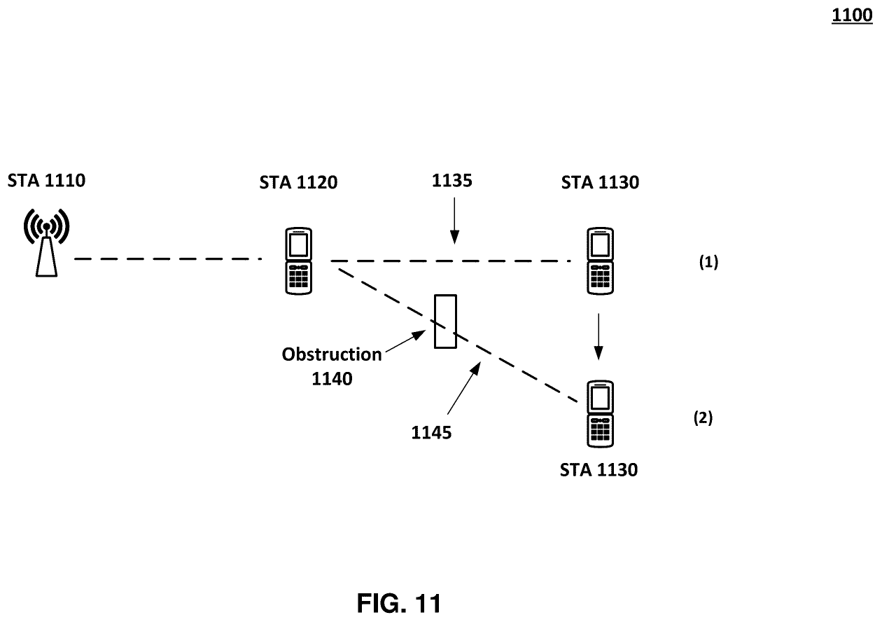

FIG. 11 illustrates an example 1100 of an obstruction changing link quality between a relay and destination STA. As shown in FIG. 11, example 1100 includes a STA 1110, a STA 1120, and a STA 1130. An obstruction 1140 may be present in the vicinity of STA 1120 and/or STA 1130.

STA 1110, 1120, or 1130 may be a non-AP STA or an AP STA. STA 1120 may comprise a relay AP and a relay STA. In an example, STA 1110 may be an AP STA and STA 1130 may be a non-AP STA, or vice versa. In another example, STAs 1110 and 1130 both may be AP STAs or non-AP STAs.

Due to unreliable communication or to extend the range of existing communication, STA 1110 may use STA 1120 as a relay to communicate with a STA 1130. As such, STA 1110 may transmit data frames destined to STA 1130 via STA 1120. STA 1110 may choose to protect the TXOP while transmitting frames to STA 1120. Similarly, STA 1120 may choose to protect the TXOP while transmitting frames to STA 1130.

STA 1120 may determine transmission parameters (e.g., modulation and coding scheme (MCS), number of spatial streams, bandwidth, resource units (RUs), etc.) for use in transmitting frames to STA 1130. The transmissions parameters may be determined based on the quality of the link between STA 1120 and STA 1130. As the quality of the link between STA 1120 and STA 1130 changes, STA 1120 may update the transmission parameters. For instance, in example 1000, at the start of communication (denoted by (1) in FIG. 11) between STA 1120 and STA 1130, STA 1130 may be in a direct line of sight of STA 1120. STA 1120 may determine first transmission parameters based on measurements of the quality of a first link 1135 between STA 1120 and STA 1130. Subsequently, as shown in FIG. 11, STA 1120, STA 1130, and/or obstruction 1140 may move in such a way that the direct line of sight between STA 1120 and STA 1130 is lost. On detecting the change in link quality, STA 1120 may determine second transmission parameters based on measurements of the quality of a second link 1145 between 1120 and STA 1130.

In an implementation, when STA 1120 or STA 1130 detect a change in the quality of the link between STA 1120 and STA 1130, STA 1120 and STA 1130 may initiate a process to inform STA 1110 of the change in link quality.

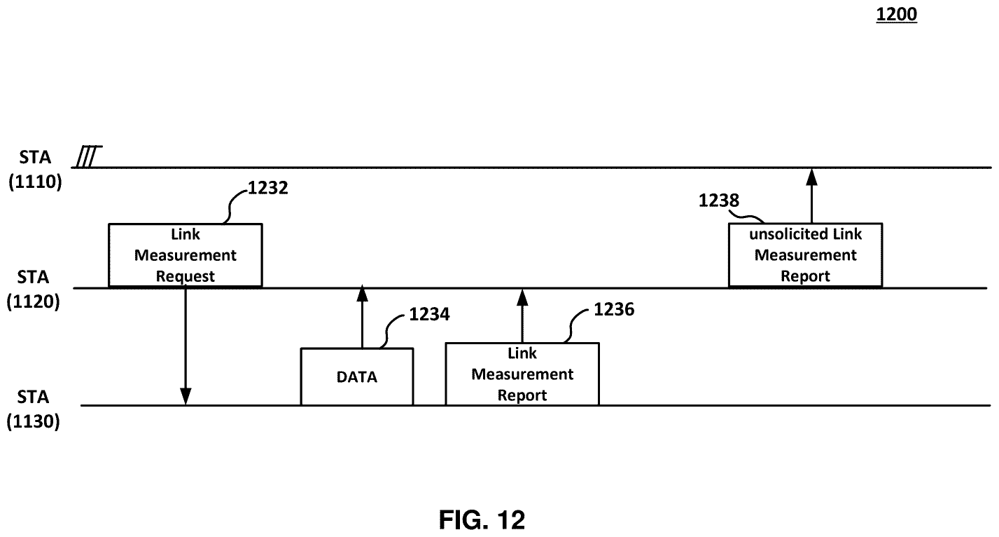

FIG. 12 illustrates an example 1200 of a procedure which may be used by STA 1120 to inform STA 1110 of a change in the quality of the link between STA 1120 and STA 1130.

As shown in FIG. 12, the procedure may begin with STA 1120 sending a Link Measurement Request frame 1232 to STA 1130. Link Measurement Request frame 1232 includes a request to STA 1130 to perform one or more link quality measurements for the link between STA 1120 and STA 1130. Upon reception of Link Measurement Request frame 1232, STA 1130 starts a link measurement report preparation process. While the link measurement report preparation process is ongoing, STA 1130 may transmit a data frame 1234 to STA 1120 or may receive a data frame (not shown in FIG. 12) from STA 1120. When the link measurement report is ready, STA 1130 may transmit a Link Measurement Report frame 1236 to STA 1120. STA 1120 may transmit an unsolicited Link Measurement Report frame 1238 to STA 1110. Unsolicited Link Measurement Report frame 1238 may include a portion of or all of Link Measurement Report frame 1236. Upon receiving unsolicited Link Measurement Report frame 1238, STA 1110 may adjust its transmission parameters for transmission to STA 1120 and/or its transmission parameters for direct transmission to STA 1130.

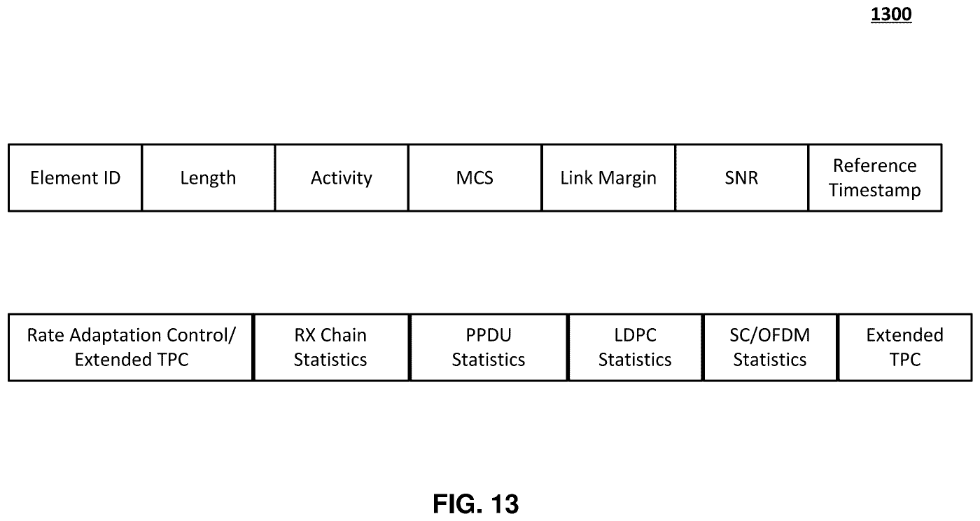

FIG. 13 illustrates an example Directional Multi-Gigabit (DMG) Link Margin Element 1300. Link Margin Element 1300 may be included in a Link Measurement Report frame, such as Link Measurement Report frame 1236. As shown in FIG. 13, example Link Margin Element 1300 may include an Element ID field, a Length field, an Activity field, an MCS, a Reference Timestamp field, Link Margin field, an SNR field, a Rate Adaptation Control/Extended Transmit Power Control field, an RX Chain Statistics field, an LDPC Statistics field, an SC/OFDM statistics field, an extended TPC field.

The Element ID field includes an identifier that identifies Link Margin Element 1300.

The Length field indicates a number of octets in Link Margin Element 1300 excluding the Element ID and Length fields.

The Activity field is set to a preferred action that a STA sending Link Margin Element 1300 recommends that a peer STA indicated in an RA field of the Link Measurement Report frame execute.

The MCS field is set to an integer representation of the MCS that the STA sending Link Margin Element 1300 recommends that the peer STA indicated in the RA field of the Link Measurement Report frame use to transmit frames to the STA sending Link Margin Element 1300.

The Link Margin field contains a measured link margin of Data frames received from the peer STA indicated in the RA field of the Link Measurement Report frame. The Link Margin field may be coded as a 2s complement signed integer in units of decibels.

The SNR field indicates an SNR measured during the reception of a PPDU.

The Reference Timestamp field contains the lower 4 octets of a timing synchronization function (TSF) timer value sampled at the instant that a MAC layer of the STA sending Link Margin Element 1300 received a PHY-CCA.indication (IDLE) primitive that corresponds to the end of the reception of a PPDU that was used to generate the feedback information contained in the Link Measurement Report frame.

The Rate Adaptation Control/Extended Transmit Power Control (TPC) field contains the number of space-time streams reported in Link Margin Element 1300 and indications of whether Link Margin Element 1300 includes optional fields used for rate adaptation and Transmit Power Control.

The RX Chain Statistics field contains received channel power indicator measurements for each RX chain at the STA sending Link Margin Element 1300.

The PPDU Statistics field provides information about each PPDU of the reported space-time Streams.

The LDPC Statistics field provides information about the LDPC decoder of the STA sending Link Margin Element 1300.

The SC/OFDM Statistics field indicates the error vector magnitude (EVM) of single-carrier (SC) data symbols or OFDM data subcarriers for PSDUs of each of the space-time streams.

The Extended TPC field provides an action that the STA sending Link Margin Element 1300 recommends that the peer STA perform for each space-time stream.

Returning to FIG. 12, as described above, Link Measurement Report frame 1236 may be used by STA 1120 to inform STA 1110 of a change in the quality of the link between STA 1120 and STA 1130. STA 1110 may use the information to adjust its own transmission parameters used for transmission to STA 1120. However, the procedure of FIG. 12 does not allow STA 1110 to determine and/or set the transmission parameters (and, particularly, the link adaptation parameters) for use by STA 1120 for transmission to STA 1130. In one aspect, Link Measurement Report frame 1236 does not include sufficient information for STA 1110 to determine the link adaptation parameters for the link between STA 1120 and STA 1130. In another aspect, the procedure of FIG. 12 does not permit STA 1110 to control the setting of transmission parameters at STA 1120. This may result in sub-optimal resource allocation and/or increased interference in the BSS. For example, lack of knowledge and/or control of these transmission parameters by STA 1110 may result in STA 1110 overestimating the amount of data that can be transmitted between STA 1110 and STA 1130 in a given TXOP obtained by STA 1110. This can lead to STA 1110 not being able to transmit all of the data frames scheduled for transmission during the current TXOP and may cause some of the data frames to be delayed as they will need to be transmitted in a subsequent TXOP to be obtained by STA 1110. In another aspect, the lack of knowledge and/or control of the transmission parameters by STA 1110 may limit the ability of STA 1110 to control the interference caused by transmissions of STA 1120.

Embodiments of the present disclosure, as further described below, address this problem that may arise in existing technologies. In one aspect, a first STA receives from a second STA a first frame comprising link adaptation feedback for a link between the second STA and a third STA. The first STA may be a source STA, the second STA may be a relay, and the third STA is a destination STA. The link adaptation feedback for the link between the second STA and the third STA may comprise information transmitted by the second STA to the first STA and that may be used by the first STA to adapt an MCS, a number of spatial streams, a bandwidth, a link/channel, a transmit power and/or an RU allocation used for transmission of data frames from the second STA to the third STA via the link. The first STA transmits to the second STA a second frame comprising link adaptation information for the link between the second STA and the third STA. The link adaptation information for the link between the second STA and the third STA may comprise information transmitted by the first STA to the second STA and that may be used by the second STA to set an MCS, a number of spatial streams, a bandwidth, a link/channel, a transmit power and/or an RU allocation used for transmission of data frames from the second STA to the third STA via the link.

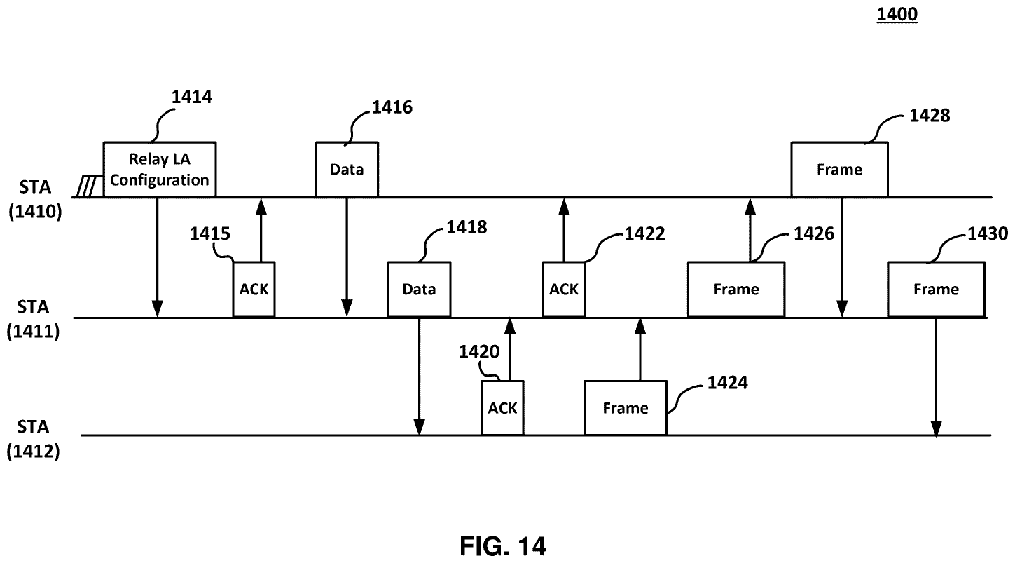

FIG. 14 is an example 1400 that illustrates a link adaptation procedure for relay communications according to an embodiment. As shown in FIG. 14, example 1400 includes STAs 1410, 1411, and 1412. STAs 1410 and 1411 may be within each other's communication ranges. Similarly, STAs 1411 and 1412 may be within each other's communication ranges. In an example, however, STAs 1410 and 1412 may not be within each other's communication ranges. For example, STA 1412 may be outside the communication range of STA 1410. In an example, STA 1410 may be an AP STA. However, embodiments are not limited to this example. In an example, STA 1411 may be a relay.

As shown in FIG. 14, example 1400 may begin with STA 1410 transmitting a relay link adaptation configuration frame 1414. Relay link adaptation configuration frame 1414 may include information that configures the behavior of STA 1411 upon receiving a link adaptation feedback frame from STA 1412. Relay link adaptation configuration frame 1414 may also include information that configures STA 1411 for requesting link adaptation feedback from STA 1412. In an embodiment, based on receiving relay link adaptation configuration frame 1414, STA 1411 may transmit to STA 1410 an acknowledgement frame 1415, to indicate the reception of relay link adaptation configuration frame 1414.

In an embodiment, STA 1410 may transmit a data frame 1416 comprising one or more data units for transmission to STA 1412 via STA 1411. Upon receiving data frame 1416, STA 1411 may transmit a data frame 1418 to STA 1412. Data frame 1418 may comprise one or more data units of data frame 1416. Upon receiving data frame 1418, STA 1412 may send an acknowledgement frame 1420 to STA 1411. Acknowledgment frame 1420 may indicate the reception status of one or more data units of data frame 1418. Acknowledgment frame 1420 may be a block acknowledgement frame. Upon receiving acknowledgement frame 1420, STA 1411 may send an acknowledgment frame 1422 to STA 1410. Acknowledgment frame 1422 may indicate the reception status at STA 1412 of one or more data units of data frame 1418 and/or the reception status at STA 1411 of one or more data units of data frame 1416. Acknowledgment frame 1422 may be a block acknowledgment frame.

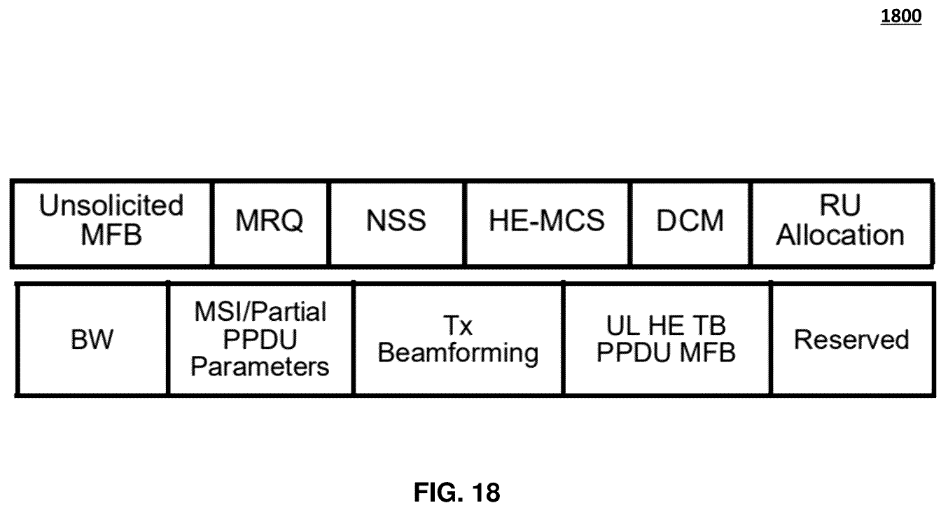

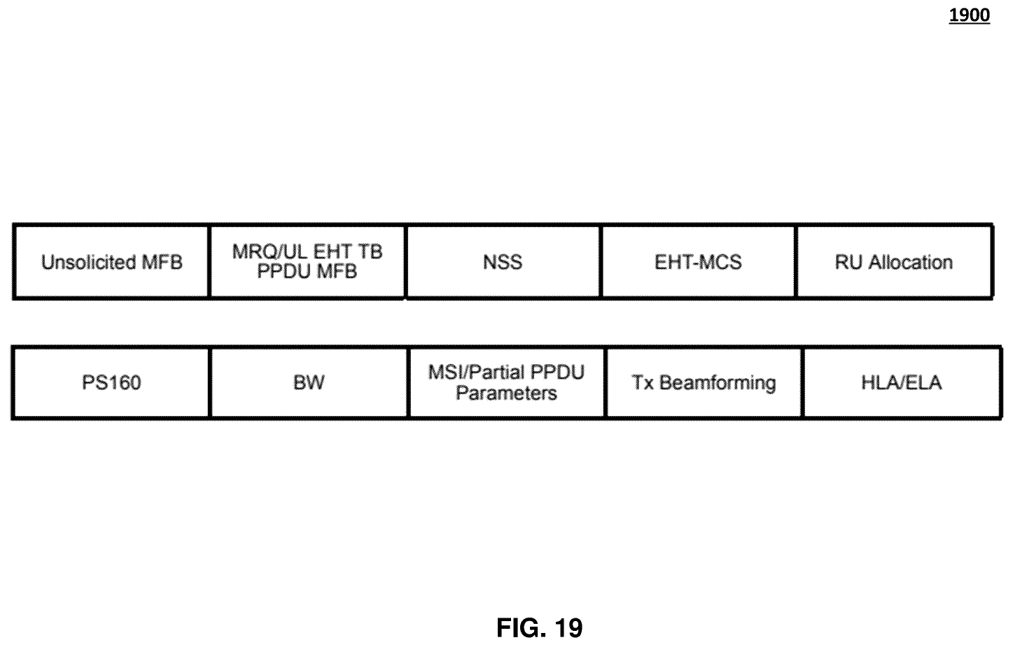

In an embodiment, e.g., on detecting a change in the link from STA 1411, STA 1412 may be configured to transmit to STA 1411 a frame 1424 comprising first link adaptation feedback for the link between STA 1411 and STA 1412. The first link adaptation feedback for the link between STA 1411 and STA 1412 may comprise information transmitted by STA 1412 to STA 1411 and that may be used by STA 1411 to adapt an MCS, a number of spatial streams, a bandwidth, a link/channel, a transmit power and/or an RU allocation used for transmission of data frames from STA 1411 to STA 1412 via the link between STA 1411 and STA 1412. STA 1412 may determine the first link adaptation feedback based one or more PPDUs received by STA 1412 from STA 1411 in a window preceding the transmission of frame 1424. In an implementation, frame 1424 may comprise one or more High Efficiency (HE) link adaptation (HLA) control subfield as illustrated FIG. 18 or one or more Extremely High Through (EHT) link adaptation (ELA) control subfield as illustrated in FIG. 19. The HLA/ELA control subfield may comprise the first link adaptation feedback.

In an embodiment, e.g., after receiving frame 1424, STA 1411 may be configured to transmit to STA 1410 a frame 1426 comprising second link adaptation feedback for the link between STA 1411 and STA 1412. The second link adaptation feedback for the link between STA 1411 and STA 1412 may comprise information transmitted by STA 1412 to STA 1411 and that may be used by STA 1411 to adapt an MCS, a number of spatial streams, a bandwidth, a link/channel, a transmit power and/or an RU allocation used for transmission of data frames from STA 1411 to STA 1412 via the link between STA 1411 and STA 1412. The second link adaptation feedback may be identical to or different than the first link adaptation feedback.

In an implementation, frame 1426 may comprise one or more HLA control subfield as illustrated FIG. 18 or one or more ELA control subfield as illustrated in FIG. 19. The HLA/ELA control subfield may comprise the second link adaptation feedback.

In an embodiment, upon receiving frame 1424, STA 1411 may compare the first link adaptation feedback in frame 1424 with stored link adaptation feedback for the link between STA 1411 and STA 1412. The stored link adaptation feedback may have been received in a previous frame comprising link adaptation feedback from STA 1412. If STA 1411 determines a difference between the first link adaptation feedback and the stored link adaptation feedback, STA 1411 may transmit to STA 1410 frame 1426 comprising the first link adaptation feedback as the second link adaptation feedback. In an embodiment, frame 1426 may be identical to frame 1424. In an embodiment, STA 1411 may store the first link adaptation feedback when the first link adaptation feedback is different than the stored link adaptation feedback. In another embodiment, STA 1411 may not compare the first link adaptation feedback to stored link adaptation feedback and may directly transmit to STA 1410 frame 1426 comprising the first link adaptation feedback as the second link adaptation feedback.

In another embodiment, upon receiving frame 1424, STA 1411 may determine whether the first link adaptation feedback comprised in frame 1424 is compatible with STA 1411. For example, STA 1411 may check whether STA 1411 may support an MCS, a number of spatial streams, a bandwidth, a link/channel, a transmit power and/or an RU allocation indicated in the first link adaptation feedback. In an embodiment, if STA 1411 does not support an MCS, a number of spatial streams, a bandwidth, a link/channel, a transmit power and/or an RU allocation indicated in the first link adaptation feedback, STA 1411 may be configured to modify one or more of an MCS, a number of spatial streams, a bandwidth, a link/channel, a transmit power and/or an RU allocation to generate the second link adaptation feedback.

In an embodiment, frame 1426 may further comprise link adaptation feedback for the link between STA 1410 and STA 1411.

In an embodiment, on receiving frame 1426 from STA 1411, STA 1410 may be configured to transmit to STA 1411 a frame 1428 comprising link adaptation information for the link between STA 1411 and STA 1412. The link adaptation information may comprise information transmitted by STA 1410 to STA 1411 and that may be used by STA 1411 to set transmission parameters (e.g., an MCS, a number of spatial streams, a bandwidth, and/or an RU allocation) used for transmission of data frames from STA 1411 to STA 1412 via the link between STA 1411 and STA 1412. In an embodiment, STA 1410 may determine the link adaptation information based on one or more parameters, including an amount of data buffered at STA 1410 for STA 1412, estimates of signal-to-interference-and-noise (SINR) ratios for one or more (or all) RUs of the link between STA 1411 and STA 1412, capabilities (e.g., supported MCS(s), supported number of spatial streams, supported bandwidth(s), supported RU allocation sizes) of STA 1411 and/or STA 1412, and estimates of congestion over the link (e.g., the number of OBSS(s), the number of STAs associated with STA 1410, etc.).

In another embodiment, on receiving frame 1426 from STA 1411, STA 1410 may set transmission parameters for the link between STA 1410 and 1411 based on link adaptation feedback from STA 1411 comprised in frame 1426.

On receiving frame 1428 from STA 1410, STA 1411 may determine, based on the link adaptation information comprised in frame 1428, whether the transmission parameters (e.g., an MCS, a number of spatial streams, a bandwidth, a link/channel, a transmit power and/or an RU allocation) used for transmission of data frames from STA 1411 to STA 1412 must be changed. If the answer is yes, STA 1411 may update the transmission parameters and may transmit to STA 1412 a frame 1430 comprising the link adaptation information indicated in frame 1428. In an embodiment, frame 1430 may be a data frame, and the link adaptation information may be provided in a PHY header of the data frame.

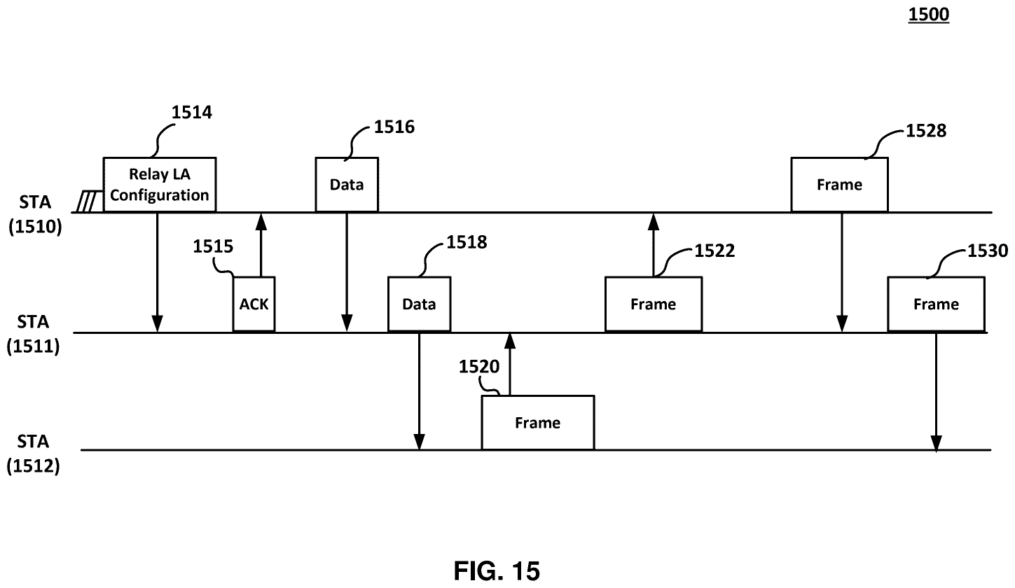

FIG. 15 is an example 1500 that illustrates a link adaptation procedure for relay communications according to an embodiment. As shown in FIG. 15, example 1500 includes STAs 1510, 1511, and 1512. STAs 1510 and 1511 may be within each other's communication ranges. Similarly, STAs 1511 and 1512 may be within each other's communication ranges. In an example, however, STAs 1510 and 1512 may not be within each other's communication ranges. For example, STA 1512 may be outside the communication range of STA 1510. In an example, STA 1510 may be an AP STA. However, embodiments are not limited to this example. In an example, STA 1511 may be a relay.

As shown in FIG. 15, example 1500 may begin with STA 1510 transmitting a relay link adaptation configuration frame 1514. Relay link adaptation configuration frame 1514 may include information that configures the behavior of STA 1511 upon receiving a link adaptation feedback frame from STA 1512. Relay link adaptation configuration frame 1514 may also include information that configures STA 1511 for requesting link adaptation feedback from STA 1512. In an embodiment, based on receiving relay link adaptation configuration frame 1514, STA 1511 may transmit to STA 1510 an acknowledgement frame 1515, to indicate the reception of relay link adaptation configuration frame 1514.

In an embodiment, STA 1510 may transmit a data frame 1516 destined to STA 1512 via STA 1511. Upon receiving data frame 1516, STA 1511 may transmit a data frame 1518 to STA 1512. Data frame 1518 may comprise one or more data units of data frame 1516. Upon receiving data frame 1518, STA 1512 may send a frame 1520. In an embodiment, frame 1520 may comprise an acknowledgement frame and first link adaptation feedback for the link between STA 1511 and STA 1512. The acknowledgment frame of frame 1520 may indicate the reception status of one or more data units of data frame 1518. The acknowledgment frame of frame 1520 may be a block acknowledgment frame.

The first link adaptation feedback may comprise information transmitted by STA 1512 to STA 1511 and that may be used by STA 1511 to adapt an MCS, a number of spatial streams, a bandwidth, a link/channel, a transmit power and/or an RU allocation used for transmission of data frames from STA 1511 to STA 1512 via the link between STA 1511 and STA 1512. STA 1512 may determine the first link adaptation feedback based one or more PPDUs received by STA 1512 from STA 1511 in a window preceding the transmission of frame 1520. In an implementation, frame 1520 may comprise one or more High Efficiency (HE) link adaptation (HLA) control subfield as illustrated FIG. 18 or one or more Extremely High Through (EHT) link adaptation (ELA) control subfield as illustrated in FIG. 19. The HLA/ELA control subfield may comprise the first link adaptation feedback.

Upon receiving frame 1520, STA 1511 may send a frame 1522 to STA 1510. Frame 1522 may comprise an acknowledgement frame and second link adaptation feedback for the link between STA 1511 and STA 1512.

In an embodiment, upon receiving frame 1520, STA 1511 may compare the first link adaptation feedback in frame 1520 with stored link adaptation feedback for the link between STA 1511 and STA 1512. The stored link adaptation feedback may have been received in a previous frame comprising link adaptation feedback from STA 1512. If STA 1511 determines a difference between the first link adaptation feedback and the stored link adaptation feedback, STA 1511 may transmit to STA 1510 frame 1522 comprising the first link adaptation feedback as the second link adaptation feedback. In an embodiment, STA 1511 may store the first link adaptation feedback when the first link adaptation feedback is different than the stored link adaptation feedback. In another embodiment, STA 1511 may not compare the first link adaptation feedback to stored link adaptation feedback and may directly transmit to STA 1510 frame 1522 comprising the first link adaptation feedback as the second link adaptation feedback.

In another embodiment, upon receiving frame 1520, STA 1511 may determine whether the first link adaptation feedback comprised in frame 1520 is compatible with STA 1511. For example, STA 1511 may check whether STA 1511 may support an MCS, a number of spatial streams, a bandwidth, a link/channel, a transmit power and/or an RU allocation indicated in the first link adaptation feedback. In an embodiment, if STA 1511 does not support an MCS, a number of spatial streams, a bandwidth, a link/channel, a transmit power and/or an RU allocation indicated in the first link adaptation feedback, STA 1511 may be configured to modify one or more of an MCS, a number of spatial streams, a bandwidth, a link/channel, a transmit power and/or an RU allocation to generate the second link adaptation feedback.

In an embodiment, the acknowledgment frame of frame 1522 may indicate the reception status at STA 1512 of one or more data units of data frame 1518 and/or the reception status at STA 1511 of one or more data units of data frame 1516. The acknowledgment frame of frame 1522 may be a block acknowledgment frame.

In an embodiment, frame 1522 may further comprise link adaptation feedback for the link between STA 1510 and STA 1511.

In an embodiment, on receiving frame 1522 from STA 1511, STA 1510 may be configured to transmit to STA 1511 a frame 1528 comprising link adaptation information for the link between STA 1511 and STA 1512. The link adaptation information may comprise information transmitted by STA 1510 to STA 1511 and that may be used by STA 1511 to set transmission parameters (e.g., an MCS, a number of spatial streams, a bandwidth, a link/channel, a transmit power and/or an RU allocation) used for transmission of data frames from STA 1411 to STA 1512 via the link between STA 1511 and STA 1512. In an embodiment, STA 1510 may determine the link adaptation information based on one or more parameters, including an amount of data buffered at STA 1510 for STA 1512, estimates of signal-to-interference-and-noise (SINR) ratios for one or more (or all) RUs of the link between STA 1511 and STA 1512, capabilities (e.g., supported MCS(s), supported number of spatial streams, supported bandwidth(s), supported RU allocation sizes) of STA 1511 and/or STA 1512, and estimates of congestion over the link (e.g., the number of OBSS(s), the number of STAs associated with STA 1510, etc.).

In another embodiment, on receiving frame 1522 from STA 1511, STA 1510 may set transmission parameters for the link between STA 1510 and 1511 based on link adaptation feedback from STA 1511 comprised in frame 1522.

On receiving frame 1528 from STA 1510, STA 1511 may determine, based on the link adaptation information comprised in frame 1528, whether the transmission parameters (e.g., an MCS, a number of spatial streams, a bandwidth, a link/channel, a transmit power and/or an RU allocation) used for transmission of data frames from STA 1511 to STA 1512 must be changed. If the answer is yes, STA 1511 may update the transmission parameters and may transmit to STA 1512 a frame 1530 comprising the link adaptation information indicated in frame 1528. In an embodiment, frame 1530 may be a data frame, and the link adaptation information may be provided in a PHY header of the data frame.

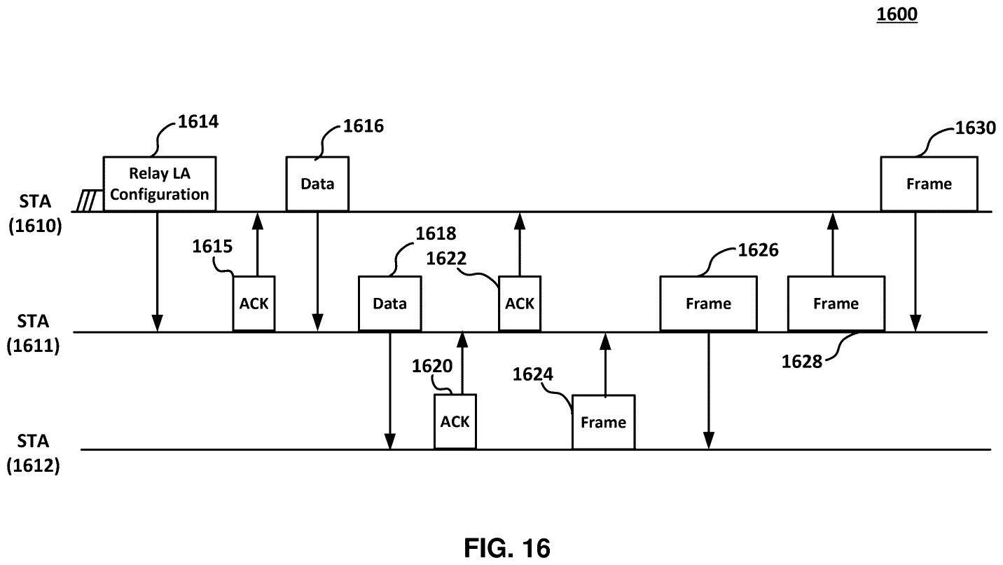

FIG. 16 is an example 1600 that illustrates a link adaptation procedure for relay communications according to an embodiment. As shown in FIG. 16, example 1600 includes STAs 1610, 1611, and 1612. STAs 1610 and 1611 may be within each other's communication ranges. Similarly, STAs 1611 and 1612 may be within each other's communication ranges. In an example, however, STAs 1610 and 1612 may not be within each other's communication ranges. For example, STA 1612 may be outside the communication range of STA 1610. In an example, STA 1610 may be an AP STA. However, embodiments are not limited to this example. In an example, STA 1611 may be a relay.

As shown in FIG. 16, example 1600 may begin with STA 1610 transmitting a relay link adaptation configuration frame 1614. Relay link adaptation configuration frame 1614 may include information that configures the behavior of STA 1611 upon receiving a link adaptation feedback frame from STA 1612. Relay link adaptation configuration frame 1614 may also include information that configures STA 1611 for requesting link adaptation feedback from STA 1612. In an embodiment, based on receiving relay link adaptation configuration frame 1614, STA 1611 may transmit to STA 1610 an acknowledgement frame 1615, to indicate the reception of relay link adaptation configuration frame 1614.

In an embodiment, STA 1610 may transmit a data frame 1616 comprising one or more data units for transmission to STA 1612 via STA 1611. Upon receiving data frame 1616, STA 1611 may transmit a data frame 1618 to STA 1612. Data frame 1618 may comprise one or more data units of data frame 1616. Upon receiving data frame 1618, STA 1612 may send an acknowledgement frame 1620 to STA 1611. Acknowledgment frame 1620 may indicate the reception status of one or more data units of data frame 1618. Acknowledgment frame 1620 may be a block acknowledgement frame. Upon receiving acknowledgement frame 1620, STA 1611 may send an acknowledgment frame 1622 to STA 1610. Acknowledgment frame 1622 may indicate the reception status at STA 1612 of one or more data units of data frame 1618 and/or the reception status at STA 1611 of one or more data units of data frame 1616. Acknowledgment frame 1622 may be a block acknowledgment frame.

In an embodiment, e.g., on detecting a change in the link from STA 1611, STA 1612 may be configured to transmit to STA 1611 a frame 1624 comprising first link adaptation feedback for the link between STA 1611 and STA 1612. The first link adaptation feedback for the link between STA 1611 and STA 1612 may comprise information transmitted by STA 1612 to STA 1611 and that may be used by STA 1611 to adapt an MCS, a number of spatial streams, a bandwidth, a link/channel, a transmit power and/or an RU allocation used for transmission of data frames from STA 1611 to STA 1612 via the link between STA 1611 and STA 1612. STA 1612 may determine the first link adaptation feedback based one or more PPDUs received by STA 1612 from STA 1611 in a window preceding the transmission of frame 1624. In an implementation, frame 1624 may comprise one or more High Efficiency (HE) link adaptation (HLA) control subfield as illustrated FIG. 18 or one or more Extremely High Through (EHT) link adaptation (ELA) control subfield as illustrated in FIG. 19. The HLA/ELA control subfield may comprise the first link adaptation feedback.

In an embodiment, e.g., after receiving frame 1624, STA 1611 may be configured to transmit to STA 1612 a frame 1626 comprising link adaptation information for the link between STA 1611 and STA 1612. The link adaptation information may comprise information transmitted by STA 1610 to STA 1611 and that may be used by STA 1611 to set transmission parameters (e.g., an MCS, a number of spatial streams, a bandwidth, a link/channel, a transmit power and/or an RU allocation) used for transmission of data frames from STA 1611 to STA 1612 via the link between STA 1611 and STA 1612. In an embodiment, STA 1611 may determine the link adaptation information based on one or more parameters, including an amount of data buffered at STA 1611 for STA 1612, estimates of signal-to-interference-and-noise (SINR) ratios for one or more (or all) RUs of the link between STA 1611 and STA 1612, and/or capabilities (e.g., supported MCS(s), supported number of spatial streams, supported bandwidth(s), supported RU allocation sizes) of STA 1611 and/or STA 1612.

In an embodiment, after transmitting frame 1626 to STA 1612, STA 1611 may be configured to transmit to STA 1610, a frame 1628. Frame 1628 may comprise link adaptation information for the link between STA 1611 and STA 1612. The link adaptation information in frame 1628 may comprise the same information transmitted by STA 1611 to STA 1612 in frame 1626. Frame 1628 may be an announcement frame.

On receiving frame 1628 from STA 1611, STA 1610 may determine, based on the link adaptation information comprised in frame 1628, whether the transmission parameters (e.g., an MCS, a number of spatial streams, a bandwidth, a link/channel, a transmit power and/or an RU allocation) used for transmission of data frames from STA 1611 to STA 1612 must be changed. If the answer is yes, STA 1610 may update the transmission parameters and may transmit to STA 1611 a frame 1630 comprising updated link adaptation information for the link between STA 1611 and STA 1612.

In an embodiment, if frame 1630 changes the transmission parameters indicated in frame 1628, STA 1611 may update the transmission parameters and may transmit to STA 1512 a further frame (not shown in FIG. 16) comprising the updated link adaptation information indicated in the frame 1630.

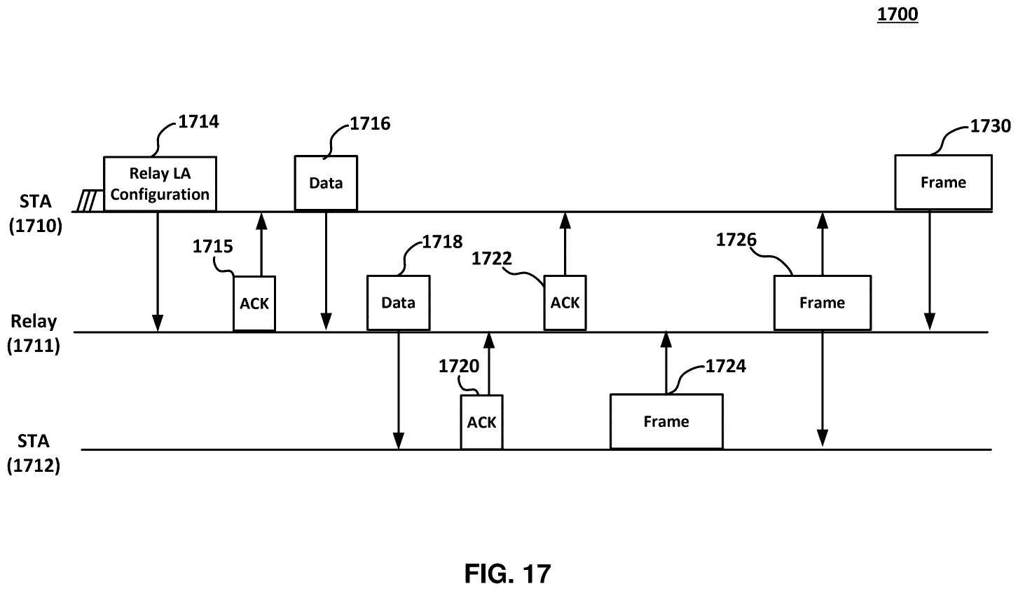

FIG. 17 is an example 1700 that illustrates a link adaptation procedure for relay communications according to an embodiment. As shown in FIG. 17, example 1700 includes STAs 1710, 1711, and 1712. STAs 1710 and 1711 may be within each other's communication ranges. Similarly, STAs 1711 and 1712 may be within each other's communication ranges. In an example, however, STAs 1710 and 1712 may not be within each other's communication ranges. For example, STA 1712 may be outside the communication range of STA 1710. In an example, STA 1710 may be an AP STA. However, embodiments are not limited to this example. In an example, STA 1711 may be a relay.

As shown in FIG. 17, example 1700 may begin with STA 1710 transmitting a relay link adaptation configuration frame 1714. Relay link adaptation configuration frame 1714 may include information that configures the behavior of STA 1711 upon receiving a link adaptation feedback frame from STA 1712. Relay link adaptation configuration frame 1714 may also include information that configures STA 1711 for requesting link adaptation feedback from STA 1712. In an embodiment, based on receiving relay link adaptation configuration frame 1714, STA 1711 may transmit to STA 1710 an acknowledgement frame 1715, to indicate the reception of relay link adaptation configuration frame 1714.

In an embodiment, STA 1710 may transmit a data frame 1716 comprising one or more data units for transmission to STA 1712 via STA 1711. Upon receiving data frame 1716, STA 1711 may transmit a data frame 1718 to STA 1712. Data frame 1718 may comprise one or more data units of data frame 1716. Upon receiving data frame 1718, STA 1712 may send an acknowledgement frame 1720 to STA 1711. Acknowledgment frame 1720 may indicate the reception status of one or more data units of data frame 1718. Acknowledgment frame 1720 may be a block acknowledgement frame. Upon receiving acknowledgement frame 1720, STA 1711 may send an acknowledgment frame 1722 to STA 1710. Acknowledgment frame 1722 may indicate the reception status at STA 1712 of one or more data units of data frame 1718 and/or the reception status at STA 1711 of one or more data units of data frame 1716. Acknowledgment frame 1722 may be a block acknowledgment frame.

In an embodiment, e.g., on detecting a change in the link from STA 1711, STA 1712 may be configured to transmit to STA 1711 a frame 1724 comprising first link adaptation feedback for the link between STA 1711 and STA 1712. The first link adaptation feedback for the link between STA 1711 and STA 1712 may comprise information transmitted by STA 1712 to STA 1711 and that may be used by STA 1711 to adapt an MCS, a number of spatial streams, a bandwidth, a link/channel, a transmit power and/or an RU allocation used for transmission of data frames from STA 1711 to STA 1712 via the link between STA 1711 and STA 1712. STA 1712 may determine the first link adaptation feedback based one or more PPDUs received by STA 1712 from STA 1711 in a window preceding the transmission of frame 1724. In an implementation, frame 1724 may comprise one or more High Efficiency (HE) link adaptation (HLA) control subfield as illustrated FIG. 18 or one or more Extremely High Through (EHT) link adaptation (ELA) control subfield as illustrated in FIG. 19. The HLA/ELA control subfield may comprise the first link adaptation feedback.

In an embodiment, e.g., after receiving frame 1724, STA 1711 may be configured to transmit a frame 1726 to STA 1712 and STA 1710. Frame 1726 may be a broadcast frame. Frame 1726 may comprise link adaptation information for the link between STA 1711 and STA 1712. Frame 1726 may be an announcement frame. The link adaptation information may comprise information transmitted by STA 1710 to STA 1711 and that may be used by STA 1711 to set transmission parameters (e.g., an MCS, a number of spatial streams, a bandwidth, a link/channel, a transmit power and/or an RU allocation) used for transmission of data frames from STA 1711 to STA 1712 via the link between STA 1711 and STA 1712. In an embodiment, STA 1711 may determine the link adaptation information based on one or more parameters, including an amount of data buffered at STA 1711 for STA 1712, estimates of signal-to-interference-and-noise (SINR) ratios for one or more (or all) RUs of the link between STA 1711 and STA 1712, and/or capabilities (e.g., supported MCS(s), supported number of spatial streams, supported bandwidth(s), supported RU allocation sizes) of STA 1711 and/or STA 1712.

On receiving frame 1726 from STA 1711, STA 1710 may determine, based on the link adaptation information comprised in frame 1726, whether the transmission parameters (e.g., an MCS, a number of spatial streams, a bandwidth, a link/channel, a transmit power and/or an RU allocation) used for transmission of data frames from STA 1711 to STA 1712 must be changed. If the answer is yes, STA 1710 may update the transmission parameters and may transmit to STA 1711 a frame 1730 comprising updated link adaptation information.

If the frame 1730 changes the transmission parameters, STA 1711 may update the transmission parameters and may transmit to STA 1712 a frame comprising the link adaptation information indicated in the frame 1730.

FIG. 18 illustrates an example High Efficiency (HE) link adaptation (HLA) control subfield 1800. HLA control subfield 1800 may be included in a Link Measurement Report frame. As shown in FIG. 18, example HLA control subfield 1800 may include an unsolicited modulation and coding scheme feedback (MFB) subfield, a MCS request (MRQ) subfield, an number of spatial streams (NSS) field, a high efficiency MCS (HE-MCS) subfield, a dual carrier modulation (DCM) subfield, a resource unit (RU) allocation subfield, a bandwidth (BW) field, a MRQ sequence identifier (MSI)/Partial PPDU Parameters subfield, a Tx Beamforming subfield, an uplink high efficiency trigger based (UL HE TB) PPDU MFB subfield, and a reserved subfield.

The unsolicited MFB subfield may indicate if the HLA Control subfield is solicited or unsolicited.

The MRQ subfield may indicate if the HLA Control subfield is a response to an HLA request.

The NSS subfield may indicate recommended number of spatial streams.

The HE-MCS subfield may indicate a recommended MCS.

The DCM subfield may indicate a recommended usage of dual carrier modulation.

The RU allocation subfield may indicate a recommended RU corresponding to the recommended MCS.

The BW subfield may indicate a bandwidth for which the recommended MCS applies.

FIG. 19 illustrates an example Extremely High Throughput (EHT) link adaptation (ELA) control subfield 1900. ELA control subfield 1900 may be used in a Link Measurement Report frame. As shown in FIG. 19, example ELA control subfield 1900 may include an unsolicited MFB subfield, an MRQ/UL EHT TB PPDU MFB subfield, an NSS subfield, an EHT-MCS subfield, a PS160 subfield, a resource unit (RU) allocation subfield, a bandwidth (BW) field, an MSI/PPDU-Type subfield, a Tx Beamforming subfield, a HLA/ELA subfield.

The unsolicited MFB subfield may indicate if the ELA Control subfield is solicited or unsolicited.

The MRQ/UL EHT TB PPDU MFB is used as ELA feedback request indicator or UL EHT TB PPDU MFB indication.

The NSS subfield may indicate recommended number of spatial streams.

The EHT-MCS subfield may indicate the recommended EHT-MCS.

The PS160 subfield is for the indication of primary 160 MHz channel or second 160 MHz channel that the RU or MRU allocation applies to if the size of RU or MRU is smaller than or equal to 2×996 tones. Otherwise, the PS160 subfield is used to indicate the RU or MRU index along with the RU Allocation subfield.

The RU allocation subfield is used to indicate RU or MRU associated with the recommended EHT-MCS/RU or MRU for which the MFB requester solicits feedback.

The BW subfield may indicate a bandwidth for which the recommended MCS applies. The MSI/Partial PPDU Parameters subfield indicates the type of the PPDU and Coding type used for estimations.

The TX Beamforming subfield indicates the transmission type of the measured PPDU.

The HLA/ELA subfield indicates if the type of the Control subfield. The HLA/ELA subfield is set to 1 if the Control Information subfield is an ELA Control subfield. The HLA/ELA subfield is set to 0 if the Control Information subfield is an HLA Control subfield.

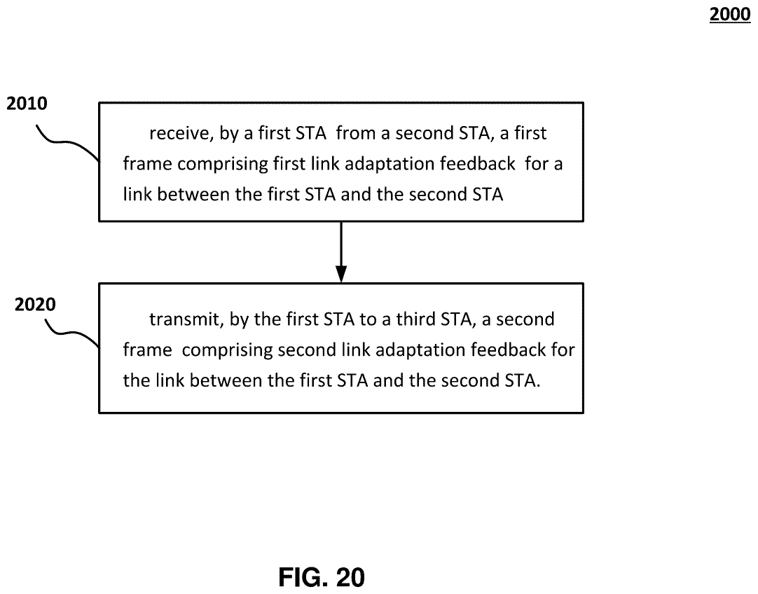

FIG. 20 illustrates an example process 2000 according to an embodiment. Example process 2000 is provided for the purpose of illustration only and is not limiting embodiments. Process 2000 may be performed by a first STA (e.g., non-AP STA or AP STA) while communicating with a second STA (e.g., non-AP STA or AP STA) and a third STA (e.g., non-AP STA or AP STA). The first STA, the second STA and the third STA may be communicatively coupled by a link (e.g., 2.4 GHz, 5 GHZ, 6 GHz, 60 GHz, etc.). The first STA may be a relay STA, the second STA may be a destination STA, and the third STA may be a source STA of a relay communication. As shown in FIG. 20, process 2000 includes steps 2010, and 2020.

As shown in FIG. 20, process 2000 begins in step 2010, which includes receiving, by the first STA from the second STA, a first frame comprising first link adaptation feedback for a link between the first STA and the second STA. In an embodiment, the first frame may comprise a High Efficiency (HE) link adaptation (HLA) or Extremely High Through (EHT) link adaptation (ELA) control subfield. In an embodiment, the HLA/ELA control subfield comprises the first link adaptation feedback.

Step 2020 may include transmitting, by the first STA to the third STA, a second frame comprising second link adaptation feedback for the link between the first STA and the second STA. In an embodiment, the second frame may comprise a High Efficiency (HE) link adaptation (HLA) or Extremely High Through (EHT) link adaptation (ELA) control subfield. In an embodiment, the HLA/ELA control subfield comprises the second link adaptation feedback.

In an embodiment, the second link adaptation feedback may be identical to the first link adaptation feedback. In another embodiment the second link adaptation feedback may be different than the first link adaptation feedback.

In an embodiment, transmitting the second frame in step 2020 may be based on the first link adaptation feedback being different than a stored link adaptation feedback.

In an embodiment, process 2000 may further include receiving, by the first STA from the third STA, a third frame comprising link adaptation information for the link between the first STA and the second STA. The third frame may be in response to the second frame. In an embodiment the first STA may transmit to the second STA, a fourth frame comprising the link adaptation information.

In an embodiment, before step 2010, process 2000 may include the first STA receiving from the third STA, a fifth frame comprising one or more data units for transmission to the second STA. The first STA may transmit to the second STA, a sixth frame comprising the one or more data units. In an embodiment, the first STA may receive from the second STA, a first BlockAck (BA) frame indicating a reception status of the one or more data units at the second STA.

In an embodiment the first frame may comprise a first BlockAck frame.

In an embodiment, the second STA may transmit to the third STA a second BlockAck frame indicating a reception status at the first STA and/or at the second STA of the one or more data units. In an embodiment, the second frame comprises the second BlockAck frame.

In an embodiment, the second frame is an announcement frame.

In an embodiment, the third frame may comprise the second frame.

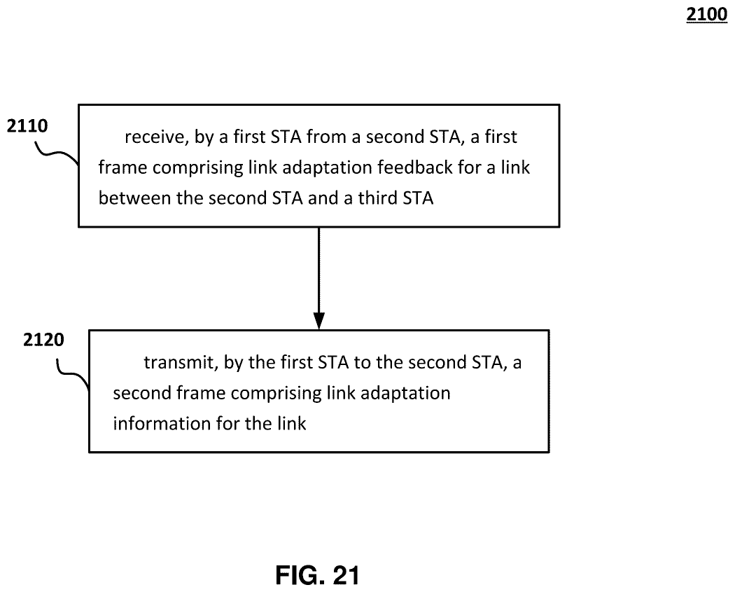

FIG. 21 illustrates an example process 2100 according to an embodiment. Example process 2100 is provided for the purpose of illustration only and is not limiting embodiments. Process 2100 may be performed by a first STA (e.g., non-AP STA or AP STA) while communicating with a second STA (e.g., non-AP STA or AP STA) and a third STA (e.g., non-AP STA or AP STA). The first STA and the second STAmay be communicatively coupled by a link (e.g., 2.4 GHz, 5 GHZ, 6 GHz, 60 GHz, etc.). The first STA may be a source STA and the second STA may be a relay STA a relay communication. As shown in FIG. 21, process 2000 includes steps 2110 and 2120.

As shown in FIG. 21, process 2100 begins in step 2110, which includes receiving, by the first STA from the second STA, a first frame comprising first link adaptation feedback for a link between the first STA and a third STA. The third STA may be a destination STA of the relay communication In an embodiment, the first frame may comprise a High Efficiency (HE) link adaptation (HLA) or Extremely High Through (EHT) link adaptation (ELA) control subfield, In an embodiment, the HLA/ELA control subfield comprises the first link adaptation feedback.

Step 2120 may include transmitting by the first STA to the second STA a second frame comprising link adaptation information for the link between the first STA and the third STA.

In an embodiment, the second frame may comprise a High Efficiency (HE) link adaptation (HLA) or Extremely High Through (EHT) link adaptation (ELA) control subfield.

In an embodiment, before step 2110, process 2100 may further comprise the first STA transmitting to the second STA, a third frame comprising one or more data units for transmission by the second STA to the third STA. In an embodiment, the first STA may receive from the second STA a first BlockAck frame indicating a reception status of the one or more data units at the third STA.

In another embodiment, the first BlockAck frame comprises the first frame.

In an embodiment, process 2100 may further include receiving, by the first STA from the second STA, a third frame comprising link adaptation information for the link between the second STA and the third STA.

In an embodiment, before step 2110, process 2100 may further include the first STA transmitting to the second STA, a fourth frame comprising one or more data units for transmission by the second STA to the third STA.

In an embodiment, process 2100 may further include the first STA receiving from the second STA, a first BlockAck frame indicating a reception status of the one or more data units at the second STA.

In another embodiment, process 2100 may further include the first STA receiving from the second STA, a third frame comprising link adaptation information for the link between the second STA and the third STA. The third frame may be an announcement frame.

What is claimed is:

1. A first station (STA) comprising:
one or more processors; and
memory storing instructions that, when executed by the one or more processors, cause the first STA to:
receive, from a second STA, a first frame comprising first link adaptation feedback for a link between the first STA and the second STA; and
transmit, by the first STA to a third STA, a second frame comprising second link adaptation feedback for the link between the first STA and the second STA.

2. The first STA of claim 1, wherein the first frame comprises a High Efficiency (HE) link adaptation (HLA)/Extremely High Through (EHT) link adaptation (ELA) control subfield, and wherein the HLA/ELA control subfield comprises the first link adaptation feedback.

3. The first STA of claim 1, wherein the instructions, when executed by the one or more processors, further cause the first STA to modify the first link adaptation feedback to generate the second link adaptation feedback.

4. The first STA of claim 1, wherein the instructions, when executed by the one or more processors, cause the first STA to transmit the second frame comprising the second link adaptation feedback based on the first link adaptation feedback being different than stored link adaptation feedback for the link.

5. The first STA of claim 1, wherein the third STA is configured to adapt, based on the second link adaptation feedback, a modulation and coding scheme (MCS), a number of spatial streams, a bandwidth, a transmit power, or a resource unit (RU) allocation used for data frames transmitted from the first STA to the second STA via the link.

6. The first STA of claim 1, wherein the instructions, when executed by the one or more processors, further cause the first STA to:
receive, from the third STA, a third frame comprising link adaptation information for the link; and
transmit, to the second STA, a fourth frame comprising the link adaptation information.

7. The first STA of claim 6, wherein the instructions, when executed by the one or more processors, further cause the first STA to set, based on the link adaptation information, a modulation and coding scheme (MCS), a number of spatial streams, a bandwidth, a transmit power, or a resource unit (RU) allocation used for data frames transmitted from the first STA to the second STA via the link.

8. The first STA of claim 1, further comprising:
receiving, by the first STA from the third STA, a fifth frame comprising one or more data units for transmission to the second STA; and
transmitting, by the first STA to the second STA, a sixth frame comprising the one or more data units.

9. The first STA of claim 8, wherein the instructions, when executed by the one or more processors, further cause the first STA to:
receive, from the second STA, a first BlockAck (BA) frame indicating a reception status of the one or more data units at the second STA; and
transmit, to the third STA, a second BA frame indicating the reception status of the one or more data units at the second STA.

10. The first STA of claim 9, wherein the first frame comprises the first BA frame, and wherein the second frame comprises the second BA frame.

11. A first station (STA) comprising:
one or more processors; and
memory storing instructions that, when executed by the one or more processors, cause the first STA to:
receive, from a second STA, a first frame comprising first link adaptation feedback for a link between the second STA and a third STA; and
transmit, to the second STA, a second frame comprising link adaptation information for the link.

12. The first STA of claim 11, wherein the first frame comprises a High Efficiency (HE) link adaptation (HLA)/Extremely High Through (EHT) link adaptation (ELA) control subfield, and wherein the HLA/ELA control subfield comprises the first link adaptation feedback.

13. The first STA of claim 11, wherein the second frame comprises a High Efficiency (HE) link adaptation (HLA)/Extremely High Through (EHT) link adaptation (ELA) control subfield, and wherein the HLA/ELA control subfield comprises the link adaptation information.

14. The first STA of claim 11, wherein the instructions, when executed by the one or more processors, cause the first STA to transmit the second frame based on the first link adaptation feedback being different than second link adaptation feedback for the link.

15. The first STA of claim 14, wherein the second link adaptation feedback is stored at the first STA for the link.

16. The first STA of claim 11, wherein the instructions, when executed by the one or more processors, further cause the first STA to adapt, based on the first link adaptation feedback, a modulation and coding scheme (MCS), a number of spatial streams, a bandwidth, a transmit power, or a resource unit (RU) allocation used for data frames transmitted from the second STA to the third STA via the link.

17. The first STA of claim 11, wherein the link adaptation information is used by the second STA to set a modulation and coding scheme (MCS), a number of spatial streams, a bandwidth, a transmit power, or a resource unit (RU) allocation used for data frames transmitted from the second STA to the third STA via the link.

18. The first STA of claim 11, wherein the instructions, when executed by the one or more processors, further cause the first STA to:
transmit, to the second STA, a third frame comprising one or more data units for transmission to the third STA; and
receiving, from the second STA, a first BlockAck (BA) frame indicating a reception status of the one or more data units at the third STA.

19. A non-transitory computer-readable medium comprising instructions that, when executed by one or more processors of a first station (STA), cause the first STA to:
receive, from a second STA, a first frame comprising first link adaptation feedback for a link between the first STA and the second STA; and
transmit, by the first STA to a third STA, a second frame comprising second link adaptation feedback for the link between the first STA and the second STA.

20. The non-transitory computer-readable medium of claim 19, wherein the instructions, when executed by the one or more processors, cause the first STA to modify the first link adaptation feedback to generate the second link adaptation feedback.
